(19) United States
(12) Patent Application Publication
(10) Pub. No.: US 2023/0388452 A1
(43) Pub. Date: Nov. 30, 2023

(54) DIGITAL TRIAL PLATFORM, E-COURT PORTAL SYSTEM AND A METHOD THEREOF

(71) Applicant: BAHCESEHIR UNIVERSITESI, Besiktas/Istanbul (TR)

(72) Inventors: Sirin KARADENIZ ORAN, Besiktas/Istanbul (TR); Ahmet KOSE, Besiktas/Istanbul (TR); Mehmet Esref YIGITBASI, Besiktas/Istanbul (TR); Talha DEMIRSOY, Besiktas/Istanbul (TR); Alaattin Gorkem KIZILTAS, Besiktas/Istanbul (TR)

(21) Appl. No.: 18/027,738

(22) PCT Filed: Sep. 6, 2021
(86) PCT No.: PCT/TR2021/050890

§ 371 Date: Mar. 22, 2023

(30) Foreign Application Priority Data
Sep. 23, 2020 (TR) 2020/15133

(51) Int. Cl. H04N 7/15; H04N 7/14; G06Q 50/18

(52) U.S. Cl. CPC H04N 7/15; H04N 7/147; G06Q 50/18

(57) ABSTRACT

The present invention relates to a system that allows all authorities and parties to attend trials remotely, especially to civil courts without requiring to be present in the courtroom, and a method thereof.

### TECHNICAL FIELD OF THE INVENTION

The present invention relates to a system that allows all authorities and parties to attend trials remotely, especially to civil courts without requiring to be present in the courtroom, and a method thereof.

The present invention particularly relates to a system that allows for accelerating the system operating within the justice mechanism.

### STATE OF THE ART

Courts are a form of judgment that was authorized in order to evaluate the disagreements of individuals and institutions having conflict between each other in accordance with the superiority of law, and that vary according to the structure and culture of the society.

Today, trials are held in physical environments. A trial that is held physically may be postponed due to force majeure such as natural disasters, pandemics, earthquakes, fires, human-oriented rebellions, wars, and terrorism, in which leaving the house is inconvenient or prohibited for people. Thus, the lawsuit process extends for many people who have a trial. Each year, new suits that are filed in Turkey are nearly 15 million, and the increase in the annual rate of suing is around 8%. Even when only these increases are taken into consideration, it should be noted that it is nearly impossible for the justice mechanism to get through this problem despite the fact that extremely devoted and innovative studies are carried out with the technology, personnel, and other infrastructure facilities that are available.

In the state of the art, the patent document numbered “TR2012/07466” was examined. The invention relates to a system for notifying and measuring speaking time for courts, and it enables the defendant, the plaintiff, or their attorneys, or any speakers to speak in a time that is determined by the judge or to give the same time that is spent to other speakers.

In the state of the art, the patent document numbered “CN101917415B” was examined. Said invention is a digital court system for a remote court trial in order to realize remote court trial, reduce user's cost, and improve the work efficiency of the user. The content management module of the invention is utilized in order to query and display trial information of cases that have been heard every year.

In the state of the art, the patent document numbered “CN101826168A” was examined. The invention discloses a remote digital court system that is related to the technical fields of remote identity authentication, remote video and audio transmission, and synchronization, and the like. The invention comprises a court terminal, other litigation participant terminals, and a central control terminal, which are connected to each other through a network. The invention ensures that all parties to the lawsuit are verified by means of an identity information extraction device and the status of all parties to the lawsuit is simultaneously viewed by means of an audio-visual collection device and a display device.

In the state of the art, courts that are established in the physical environment create a serious economic burden on the justice budget every year. Waiting times are long for the transactions that can be substantially realized online in a very short time, such as judicial processes that take a long time, correspondence, and identification. There is an unusual density and procedure in the current legal system, especially in the field of civil courts. Today, there is no system that accelerates the process by preventing the slowdown caused by the density that is experienced, and that offers technological and economic innovation to the justice system.

Consequently, the disadvantages disclosed above and the inadequacy of available solutions in this regard necessitated making an improvement in the relevant technical field.

### OBJECTS OF THE INVENTION

The present invention relates to a system that allows all authorities and parties to attend trials remotely, especially to civil courts without requiring to be present in the courtroom, and a method thereof.

An object of the present invention is to ensure that all the participants in a current court of law can completely fulfill their legal rights, obligations, duties, and responsibilities in the electronic environment.

Another object of the present invention is to ensure that all works and transactions carried out in the field of national jurisdiction, especially in civil courts, are carried out in an electronic environment.

Yet another object of the present invention is to allow for using it in the scripted case training in law faculties and in the training of judges and prosecutors in the academy of justice.

Yet another object of the present invention is to provide a strong system security by means of using closed source code and end-to-end encryption.

Structural and characteristic features of the present invention as well as all advantages thereof will be understood more clearly from figures disclosed below and the detailed description written by making references to these figures. Therefore, the assessment should be made by taking these figures and the detailed description into consideration.

### DESCRIPTION OF THE FIGURES

FIG. 1 illustrates a view of schematic flow diagram of the system according to the present invention.

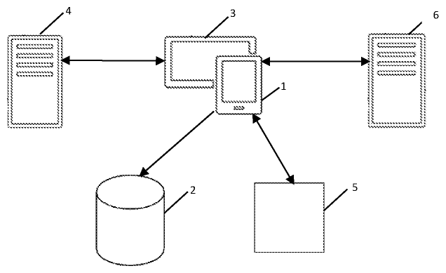

### REFERENCE NUMERALS

1. Electronic Device
2. Database
3. Application
4. Socket Server
5. Translation Unit
6. ICE Server

### DESCRIPTION OF THE INVENTION

The present invention relates to a system that allows all authorities and parties to attend trials remotely, especially to civil courts without requiring to be present in the courtroom, and a method thereof.

The system according to the present invention basically consists of electronic device (1), database (2), application (3), socket server (4), translation unit (5), and ICE server (6).

Electronic device (1) enables that at least one application (3) may be executed thereon, that users may communicate through audio and video, and make data exchange. Electronic device (1) is a device that is capable of performing data exchange through a data network, such as a smart phone, tablet, computer. In an embodiment of the present invention, the electronic device (1) provides data exchange through a data network such as a wireless connection or Internet. Users provide data entries to the application (3) through the electronic device (1).

Database (2) allows for storing the publications such as all written laws, regulations, bylaws, and precedents.

Application (3) is executed on the electronic device (1). Application (3) enables users to log in with their information and digital encryption. Application (3) offers the areas that users can access in accordance with their authorization by means of an interface. Application (3) transmits the entered information to the socket server (4), thereby allowing users to access home screen of the application (3). Application (3) enables the users participating in the courtroom to communicate with audio and video by means of socket server (4). Application (3) may have a plurality of interfaces such as the reconciliatory interface that is used in reconciliation cases, and the serial court interface. Application (3) comprises separate interfaces that are designed for appeal, general procedure, simplified procedure, and within the framework stipulated by the law, notary transactions. Application (3) allows for displaying the information that is provided by the socket server (4), and that is requested during the inquiry, to the users. Application (3) enables the judge to see the results of the query and verification with the certificate of identity register copy. Application (3) enables that the judge verifies the identification results. Application (3) enables that the minute book is displayed to the court clerk after the identity information is verified. Application (3) provides the text form of the voice conversations in the communication that is realized, which has been converted into text by the translation unit (5) to the court clerk, thereby enabling the court clerk to make changes thereon. Application (3) allows the certified interpreter and the record clerk to watch the same screen in case of any request of the judge or one of the parties. The administrative authority of the application (3) is made by the trial judge. On the application (3), all authorization such as initiating the trial, giving the right to speak to the defense, plaintiff, and witness positions of the parties, accepting or rejecting the presented document/evidence are carried out by the judge. Application (3) allows instant access to publications such as all written laws, regulations, bylaws, and precedents, etc., which are still in force in our country, through the database (2). In one embodiment of the present invention, the application (3) allows for carrying out the notary transactions in case a legal regulation is made. Application (3) may be used by virtual users for law school scripted-training modulations. Thus, an experience that is close to reality is provided in legal education. Application (3) ensures that the decisions made by the judge and the minutes are recorded on the system that is being integrated by the socket server (4).

Socket server (4) provides the connection between the electronic devices (1) that will interact. Socket server (4) allows communication with audio and video of the users with each other through the application (3). Socket server (4) enables the users to connect with each other as peer-to-peer (P2P). Thus, audio and video are processed synchronously with each other as P2P and data that is obtained is transmitted from computer to computer without receiving any media server connection. Socket server (4) allows for automatically communicating more than one application. Socket server (4) ensures that the identity information and digital password that are requested through the application (3) are verified on the e-government and national judiciary informatics system. Socket server (4) ensures that the query data that is requested through the application (3) is analyzed and transmitted to the application (3). Socket server (4) enables that query and verification with the certificate of identity register copy are performed by means of the integration that is established via the application programming interface, which is received from the database of the Directorate General of Civil Registration and Citizenship Affairs.

Translation unit (5) ensures that the communication audio data realized on the application (3) is converted into text. Translation unit (5) allows for translating from different languages with multi-language and interpreter support.

The ICE (Interactive Connectivity Establishment) server (6) enables to find ways for two computers to directly communicate with each other as far as possible in a peer-to-peer network. The ICE server (6) ensures that the outgoing and incoming audio and video exchanges are performed as encrypted in the application (3).

In a preferred embodiment of the present invention, the system architecture is created with hybrid technology by means of using WEBRTC technology and multiple software languages such as Python, Javascript, CSS, HTML and can be integrated into public applications such as NJIS and e-government. Overcoming the security problems is ensured by means of the fact that it is produced in completely domestic architecture and in a unique design without using any available source code software.

The system according to the present invention has a method of digital trial platform method. By means of said method, a peer-to-peer connection is performed with the socket server (4), and audio and video exchange are performed with the ICE server (6) in an encrypted manner, by means of audio and video communication between all authorities and parties of the trial that will attend the trial via the application (3). Said method comprises process steps in the following.

Users log in the application (3) with their identity information and digital signature through the electronic device (1).

Audio and video calls of the users are started on the application (3) with the socket server (4). The outgoing and incoming audio and video exchanges are performed as encrypted with the ICE server (6).

All authorization such as initiating the trial, giving the right to speak to the defense, plaintiff, and witness positions of the parties, accepting or rejecting the presented document/evidence are given by the judge in the application (3). The information that is requested during the query is projected on the screen of the application (3).

The judge performs the identification on the external database through the application (3). The minutes are projected to the screen of the court clerk's computer on the application (3) after the identification.

All conversations in the communication realized in the application (3) are converted into text by means of the translation unit (5) and projected on the application (3) screen such that the court clerk can make changes.

Incoming/outgoing audio and video to the application (3) are processed synchronously as peer-to-peer with the socket server (4).

Users can instantly access all written laws, regulations, bylaws, and precedents, etc. that are in force in our country through the application (3).

The decisions made and the minutes are sent to the socket server (4) in order to be recorded in the relevant databases.

1. A system that allows for accelerating the system operating within the justice mechanism characterized in that, it comprises;
at least one electronic device (1) which enables that at least one application (3) may be executed thereon, that users may communicate through audio and video, and make data exchange,
at least one database (2) that allows for storing the publications such as all written laws, regulations, bylaws, and precedents,
at least one application (3) that is executed on the electronic device (1), that enables users to log in with their information and digital encryption, and offers the areas that users can access according to their authorization by means of an interface, and transmits the entered information to a socket server (4), thereby allowing users to access a home screen, and enables the users participating in a courtroom to communicate with audio and video by means of socket server (4), and includes separate interfaces, which are designed for appeal, general procedure, simplified procedure, and within the framework stipulated by the law, notary transactions, and enables the judge to see the results of the query and verification with the certificate of identity register copy,
at least one socket server (4) that enables the users to communicate with each other via audio and video through the application (3) and to automatically communicate with the application (3) with external applications by being integrating with more than one external application by means of establishing the connection between the electronic devices (1) that will interact with each other,
at least one translation unit (5) which enables that communication audio data realized on the application (3) is converted into text,
an ICE server (6) that enables to find ways for two computers to directly communicate with each other as far as possible in a peer-to-peer network, and allows for performing the outgoing and incoming audio and video exchanges as encrypted in the application (3).

2. A digital trial method of a system, characterized in that, it comprises the process steps of;
Logging in the application (3) by the users with their identity information and digital signature through the electronic device (1),
Starting audio and video calls of the users on the application (3) with the socket server (4),
Performing the outgoing and incoming audio and video exchanges as encrypted with the ICE server (6),
Giving all authorization such as initiating the trial, giving the right to speak to the defense, plaintiff, and witness positions of the parties, accepting or rejecting the presented document/evidence by the judge in the application (3),
Projecting the information that is requested during the query on the screen of the application (3),
Performing the identification on the external database on the application (3) by the judge,
Projecting the minutes to the screen of the court clerk's computer through the application (3),
Projecting all conversations in the communication realized in the application (3) by converting them into text with the translation unit (5) such that the court clerk can make changes,
Processing the incoming/outgoing audio and video to the application (3) synchronously as peer-to-peer with the socket server (4),
Instantly accessing all written laws, regulations, bylaws, and precedents, etc. that are in force in our country through the application (3) by the users,
Sending the decisions made and the minutes with the socket server (4) in order to be recorded in the relevant databases.

3. A digital trial system according to claim 1, characterized in that, it comprises an electronic device (1) that is capable of performing data exchange through a data network, such as a smart phone, tablet, computer.

4. A digital trial system according to claim 1, characterized in that, it comprises an electronic device (1) that provides data exchange through a data network such as a wireless connection or Internet.

5. (canceled)

6. (canceled)

7. (canceled)

8. A digital trial system according to claim 1, characterized in that, it comprises an application (3) that allows for displaying the information that is provided by the socket server (4), and that is requested during the inquiry, to the users.

9. (canceled)

10. A digital trial system according to claim 1, characterized in that, it comprises an application (3) that enables the judge to verify the identification results.

11. A digital trial system according to claim 1, characterized in that, it comprises an application (3) which enables that the minute book is displayed to the court clerk after the identity information is verified.

12. A digital trial system according to claim 1, characterized in that, it comprises an application (3) that provides the text form of the voice conversations in the communication realized, which has been converted into text by the translation unit (5), to the court clerk, thereby enabling the court clerk to make changes thereon.

13. A digital trial system according to claim 1, characterized in that, it comprises an application (3) that allows the certified interpreter and the record clerk to watch the same screen in case of any request of the judge or one of the parties.

14. A digital trial system according to claim 1, characterized in that, it comprises an application (3) which enables that all authorization such as initiating the trial, giving the right to speak to the defense, plaintiff, and witness positions of the parties, accepting or rejecting the presented document/evidence are carried out by the judge.

15. A digital trial system according to claim 1, characterized in that, it comprises an application (3) that allows for instantly accessing the publications such as all written laws, regulations, bylaws, and precedents, etc., which are still in force in our country, through the database (2).

16. A digital trial system according to claim 1, characterized in that, it comprises an application (3) that allows for using by virtual users for law school scripted-training modulations.

17. A digital trial system according to claim 1, characterized in that, it comprises an application (3) that allows for recording the decisions made by the judge and the minutes on the system that is being integrated by the socket server (4).

18. A digital trial system according to claim 1, characterized in that, it comprises an application (3) that allows an interpreter to connect so that the voice conversations that are realized in the communication can be translated by the translation unit (5).

19. A digital trial system according to claim 1, characterized in that, it comprises a socket server (4) that allows for connecting the users each other as peer-to-peer.

20. A digital trial system according to claim 1, characterized in that, it comprises a socket server (4) that allows for verifying the identity information and digital password that are requested through the application (3) on the e-government and national judiciary informatics system.

21. A digital trial system according to claim 1, characterized in that, it comprises a socket server (4) that allows for obtaining the query data that is requested through the application and transmitting them to the application (3).

22. A digital trial system according to claim 1, characterized in that, it comprises a socket server (4) which enables that query and verification with the certificate of identity register copy are performed by means of the integration that is established via the application programming interface, which is received from the database of the Directorate General of Civil Registration and Citizenship Affairs.

23. A digital trial system according to claim 1, characterized in that, it comprises a translation unit (5) that allows for translating from different languages with multi-language and interpreter support.

24. (canceled)
